(19) United States
(12) Patent Application Publication
(10) Pub. No.: US 2007/0235556 A1
(43) Pub. Date: Oct. 11, 2007

(54) Nozzle assembly

(76) Inventors: Michael P. Harmon, Dunlap, IL (US); Cho Y. Liang, Henderson, NV (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/393,944

(22) Filed: Mar. 31, 2006

(51) Int. Cl. B05B 1/24

(52) U.S. Cl. 239/132

(57) ABSTRACT

A nozzle assembly includes a housing defining a first fluid passage and a second fluid passage, and a sleeve disposed within the housing and fluidly connected to the first and second fluid passages. The nozzle assembly also includes a shaft disposed within the sleeve and movable between a closed position and an open position. The nozzle assembly further includes at least one orifice in selective communication with a regeneration device.

### TECHNICAL FIELD

The present disclosure is directed to a nozzle assembly and, more particularly, to a nozzle assembly configured to be cooled by a fluid.

### BACKGROUND

Engines, including diesel engines, gasoline engines, natural gas engines, and other engines known in the art, may exhaust a complex mixture of air pollutants. The air pollutants may be composed of both gaseous and solid material, such as, for example, particulate matter. Particulate matter may include ash and unburned carbon particles called soot.

Due to increased environmental concerns, some engine manufacturers have developed systems to treat engine exhaust after it leaves the engine. Some of these systems employ exhaust treatment devices, such as particulate traps, to remove particulate matter from the exhaust flow. A particulate trap may include filter material designed to capture particulate matter. After an extended period of use, however, the filter material may become partially saturated with particulate matter, thereby hindering the filter material's ability to capture particulates.

The collected particulate matter may be removed from the filter material through a process called regeneration. A particulate trap may be regenerated by increasing the temperature of the filter material and the trapped particulate matter above the combustion temperature of the particulate matter, thereby burning away the collected particulate matter. This increase in temperature may be effectuated by various means. For example, some systems may employ a heating element to directly heat one or more portions of the particulate trap (e.g., the filter material or the external housing). Other systems have been configured to heat exhaust gases upstream of the particulate trap. The heated gases then flow through the particulate trap and transfer heat to the filter material and captured particulate matter. Such systems may alter one or more engine operating parameters, such as the ratio of air to fuel in the combustion chambers, to produce exhaust gases with an elevated temperature. Alternatively, such systems may heat the exhaust gases upstream of the particulate trap with, for example, a burner disposed within an exhaust conduit leading to the particulate trap.

One such system is disclosed by U.S. Pat. No. 4,651,524, issued to Brighton on Mar. 24, 1987 (“the '524 patent”). The '524 patent discloses an exhaust treatment system configured to increase the temperature of exhaust gases with a burner.

While the system of the '524 patent may increase the temperature of the particulate trap, the regeneration device of the '524 patent is not configured such that a portion of the device may be actively cooled after regenerating the particulate trap. As a result, components of the device may become clogged over time due to fuel remaining in the device while the device is at an elevated temperature after regeneration. Clogging of the device may reduce the effectiveness of the device and hinder device performance.

The disclosed nozzle assembly is directed toward overcoming one or more of the problems set forth above.

### SUMMARY OF THE INVENTION

In one exemplary embodiment of the present disclosure, a nozzle assembly includes a housing defining a first fluid passage and a second fluid passage, and a sleeve disposed within the housing and fluidly connected to the first and second fluid passages. The nozzle assembly also includes a shaft disposed within the sleeve and movable between a closed position and an open position. The nozzle assembly further includes at least one orifice in selective communication with a regeneration device.

In another exemplary embodiment of the present disclosure, a nozzle assembly includes a housing defining a first fluid passage fluidly connected to a third fluid passage, and a second fluid passage fluidly connected to a fourth fluid passage. The nozzle assembly also includes a sleeve disposed within the housing, and a shaft disposed within the sleeve and movably disposed between an open position and a closed position. The shaft defines a bypass passage configured to direct fluid from the second fluid passage to the fourth fluid passage. The nozzle assembly further includes at least one orifice in selective communication with a regeneration device.

In still another exemplary embodiment of the present disclosure, a method of cooling a portion of a nozzle assembly includes directing a fluid to a chamber of the nozzle assembly when a shaft of the nozzle assembly is in an open position. The method also includes directing a portion of the fluid from a central portion of the chamber to a bypass passage of the shaft when the shaft is in the open position.

### BRIEF DESCRIPTION OF THE DRAWINGS

FIG. 1 is a diagrammatic illustration of a nozzle assembly connected to a fluid source according to an exemplary embodiment of the present disclosure.

FIG. 2 is a diagrammatic illustration of a regeneration device connected to a power source according to another exemplary embodiment of the present disclosure.

FIG. 3 is a front view of a sleeve of the nozzle assembly illustrated in FIG. 1 according to an exemplary embodiment of the present disclosure.

### DETAILED DESCRIPTION

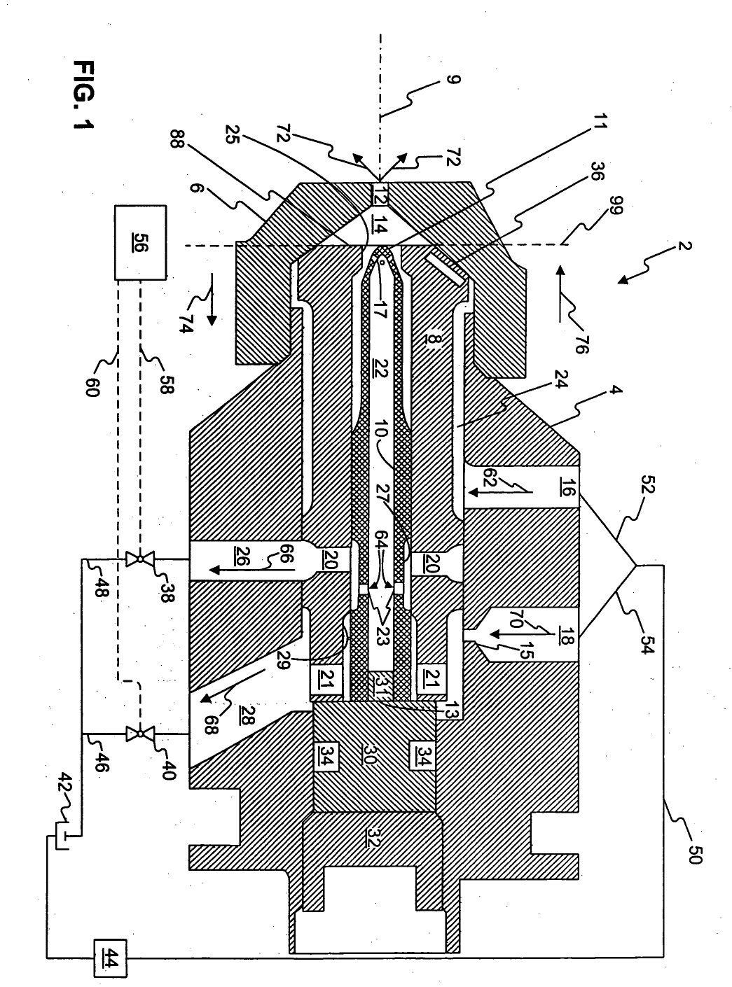

As shown in FIG. 1, a nozzle assembly 2 includes a housing 4, a cap 6, and a sleeve 8 disposed within a channel 24 of the housing 4. The nozzle assembly 2 further includes a shaft 10 movably disposed within the sleeve 8. The sleeve 8 abuts the cap 6 and a stop 30 of the nozzle assembly 2. The stop 30 and the sleeve 8 are secured against the cap 6 with a set screw 32.

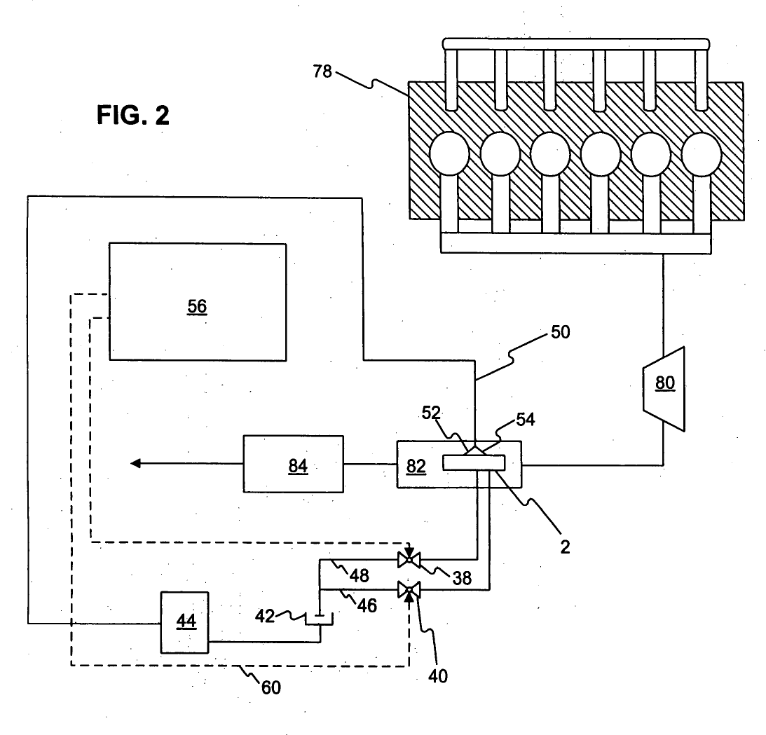

The housing 4 may be, for example, a manifold or any other like structure capable of supporting components of a nozzle assembly and assisting in forming a chamber 14 for swirling fluid to be injected by the nozzle assembly 2. As shown in FIG. 1, the cap 6, the sleeve 8, the shaft 10, the stop 30, and the set screw 32 may be at least partially supported by and/or connected to the housing 4. The housing 4 may be made of any materials known in the art capable of withstanding particulate filter regeneration temperatures. Such materials may include, for example, platinum, steel, aluminum, and/or any alloys thereof. In addition, the housing 4 may be made of cast iron or any other cast material. As will be discussed below with respect to FIG. 2, the housing 4 and/or other components of the nozzle assembly 2 may be sized and/or otherwise configured to be mounted within a regeneration device 82.

The housing 4 may define a first fluid passage 18 and a second fluid passage 16. The housing 4 may further define a third fluid passage 28 and a fourth fluid passage 26. As will be described in greater detail below, the third fluid passage 28 may be fluidly connected to the first fluid passage 18, and the fourth fluid passage 26 may be fluidly connected to the second fluid passage 16, via radial passages in, for example, the sleeve 8. In addition, each of the fluid passages 16, 18, 26, 28 may be fluidly connected to the channel 24 of the housing 4. As shown in FIG. 1, a portion of the first fluid passage 18 may define a conical restriction 15 proximate an interface between the first fluid passage 18 and a portion of the sleeve 8. This conical restriction 15 may, for example, have a smaller diameter than a diameter of the third fluid passage 28.

The cap 6 may be connected to the housing 4 in any conventional way so as to form a fluid seal therebetween. For example, the cap 6 may include threads, and the housing 4 may include corresponding threads configured to form a fluid seal when pressurized fluid is contained within the housing 4 and/or the cap 6. The fluid seal may be capable of withstanding fluid pressures in excess of, for example, 250 psi during operation of the nozzle assembly 2. The cap 6 may be made from, for example, any of the materials discussed above with respect to the housing 4. As shown in FIG. 1, the cap 6 may define at least one orifice 12. The orifice 12 may be sized, angled, and/or otherwise configured to inject a conical-shaped flow of fluid into, for example, the regeneration device 82 (FIG. 2). The cap 6 may assist in defining the chamber 14 proximate the shaft 10, and the chamber 14 may also be sized, shaped, and/or otherwise configured to assist in injecting the conical flow of fluid.

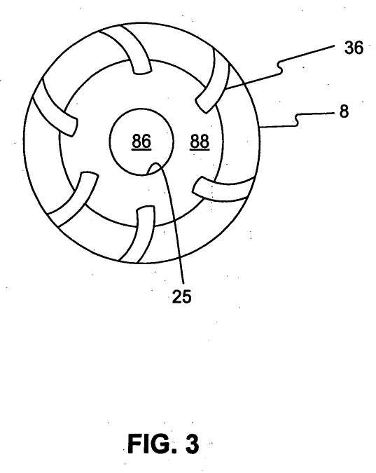

The sleeve 8 may be substantially cylindrical and substantially hollow. The sleeve 8 maybe disposed adjacent to an inner surface of the cap 6 and may be made of any of the metals discussed above with respect to the housing 4. The sleeve 8 may define a plurality of slots 36 in fluid communication with the channel 24 of the housing 4 and the chamber 14. The plurality of slots 36 may be disposed at any desirable angle to assist in injecting fluid into the chamber 14 at an angle relative to a longitudinal axis 9 of the shaft 10 and relative to a radial axis 99 of the sleeve 8. As shown in FIG. 3, the sleeve 8 may define a front face 88 and a channel 86. In an exemplary embodiment, the front face 88 may lie along the radial axis 99 and may be substantially perpendicular to the longitudinal axis 9 (FIG. 1). The slots 36 may be substantially straight or, alternatively, may be curved. Although the sleeve 8 shown in FIG. 3 includes six slots 36 (only one of which is illustrated in FIG. 1), it is understood that in other exemplary embodiments, the sleeve 8 may include more or less than six slots 36. The channel 86 may be sized and/or otherwise configured to receive the shaft 10 movably disposed therein.

Referring again to FIG. 1, the sleeve 8 may also define a first radial passage 21 and a second radial passage 20. The first radial passage 21 may assist in fluidly connecting the first fluid passage 18 to the third fluid passage 28, and the second radial passage 20 may assist in fluidly connecting the second fluid passage 16 to the fourth fluid passage 26. In addition, the first radial passage 21 may be configured to supply fluid between an end 13 of the shaft 10 and, for example, the stop 30. The first radial passage 21 may have a larger diameter and/or cross sectional area than the diameter of the conical restriction 15 of the first fluid passage 18. As will be described in greater detail below, the delivery of fluid between, for example, the end 13 of the shaft 10 and the stop 30 may assist in moving the shaft 10 within the sleeve 8.

It is understood that the first and second radial passages 21, 20 may be channels that are milled, drilled, cut, and/or otherwise formed in the sleeve 8. The first and second radial passages 21, 20 may extend substantially around a perimeter or circumference of the sleeve 8 and may be formed into a wall of the sleeve 8 or on a surface of the sleeve 8. Thus, although shown as notches in the cross-sectional view of FIG. 1, it is understood that fluid may be contained completely within the first and second radial passages 21, 20 when passing from, for example, the first fluid passage 18 to the third fluid passage 28 and from the second fluid passage 16 to the fourth fluid passage 26, respectively. As shown in FIG. 1, the sleeve 8 may include a larger inner diameter portion 29 proximate the end 13 and the first radial passage 21 may be configured to direct fluid to the larger inner diameter portion 29. Alternatively, in an exemplary embodiment (not shown), the shaft 10 may include a smaller diameter portion proximate the end 13 and the first radial passage 21 may be configured to direct fluid to the smaller diameter portion.

The shaft 10 may be substantially cylindrical and may have a substantially cone-shaped tip 11. A portion of the shaft 10 may taper towards the tip 11. The shaft 10 may be movably disposed within the sleeve 8 and may have a first or open position (shown in FIG. 1) in which the shaft 10 abuts the stop 30 and the chamber 14 is at its maximum volume. The shaft 10 may also have a second or closed position (not shown) in which the tip 11 may engage the orifice 12 of the cap 6, and the shaft 10 may substantially fluidly seal the orifice 12. The shaft 10 may be configured to move in the direction of arrow 76 when transitioning from the open position to the closed position. Conversely, the shaft 10 may be configured to move in the direction of arrow 74 when transitioning from the closed position to the open position shown in FIG. 1. As will be described in greater detail below, such movement may result from differences in fluid pressure within certain portions of, for example, the sleeve 8 and/or the housing 4. The sleeve 8 may define a reduced inner diameter portion 25 proximate the tip 11, and the tip 11 may pass through the reduced inner diameter portion 25 when the shaft 10 transitions from the open position to the closed position.

The shaft 10 may be substantially hollow and may define a bypass passage 22 therein. The shaft 10 may also include a plug 31 disposed proximate the end 13 and forming a substantially fluid seal at the end 13. The shaft 10 may further define at least one feed hole 17 proximate the tip 11. The feed holes 17 may assist in fluidly connecting, for example, the chamber 14 to the bypass passage 22. In an exemplary embodiment, the shaft 10 may define four feed holes 17 configured to direct fluid from a central portion of the chamber 14 to the bypass passage 22. Thus, the feed holes 17 may assist in fluidly connecting the bypass passage 22 to the chamber 14.

It is understood that the bypass passage 22 may be fluidly connected to, for example, the plurality of slots 36, the chamber 14, and the second radial passage 20 in both the open and the closed position. The feed holes 17 may be disposed about the tip 11 such that when the shaft 10 is in the closed position, fluid entering the chamber 14 through the slots 36 may pass through the feed holes 17 and into the bypass passage 22. The shaft 10 may also define a plurality of escape channels 23 configured to fluidly connect the bypass passage 22 with the second radial passage 20. It is understood that the bypass passage 22, the feed holes 17, and the escape channels 23 may be drilled, milled, cut, and/or otherwise formed into the shaft 10. The bypass passage 22, the feed holes 17, and the escape channels 23 may be disposed at any angle relative to the longitudinal axis 9, and may have any diameter useful in directing a flow of fluid. In an exemplary embodiment, the shaft 10 may also define an annulus 27 or other conventional indentation on an outer surface of the shaft 10. The annulus 27 may be in fluid communication with the escape channels 23 and may assist in fluidly connecting the escape channels 23 to the first radial passage 20.

The stop 30 may be, for example, any conventional mechanical spacer. The stop 30 may be made from any of the metals discussed above with respect to the housing 4 and may be sized, shaped, and/or configured to secure the sleeve 8 tightly against, for example, the cap 6 when the set screw 32 is fully tightened. The stop 30 may be substantially noncompressible and may include at least one groove configured to accept a seal 34. The seal 34 may be configured to form a fluid seal between, for example, the housing 4 and the stop 30. In an exemplary-embodiment, the seal 34 may be an O-ring made of any conventional plastic, rubber, polymer, or composite. Such materials may include, for example, Viton® or other fluoroelastomers. The seal 34 may be configured to form such a fluid seal when fluid pressures within the housing 4 exceed, for example, 250 psi, and the set screw 32 may assist in forming such a seal.

At least one valve may be fluidly connected to the housing 4 to assist in controlling the flow of fluid therein. For example, a valve 40 maybe fluidly connected to the third fluid passage 28, and a valve 38 may be fluidly connected to the fourth fluid passage 26. The valves 40, 38 may be any type of controllable two-way valve known in the art. The valves 40, 38 may include an actuation device (not shown), such as, for example, a solenoid, to assist in variably regulating a flow of fluid therethrough. A portion of each valve 40, 38, such as, for example, the actuation device, may be electrically connected to a controller 56. The dotted control lines 58, 60 shown in FIG. 1 illustrate such a connection. The controller 56 may be, for example, an electronic control unit, a computer, and/or any other conventional data processor configured to control the position and/or functionality of valves 40, 38. The valves 40, 38, may also be fluidly connected to a tank 42 by fluid lines 46, 48, respectively. The fluid lines 46, 48 may be any conventional pipes, hoses, and/or other like structures configured to transmit pressurized fluid, and the fluid lines 46, 48 may be configured to transmit fluid to and from the valves 40, 38 at pressures in excess of 250 psi.

The tank 42 may be, for example, a low pressure sump, a fuel tank, a secondary fuel circuit of a work machine, and/or any other low pressure fluid source known in the art. The tank 42 may contain, for example, diesel fuel and may be connected to a conventional pressure source, such as a pump 44. The pump 44 may be configured to draw fluid from the tank 42 and direct the drawn fluid to channels 52, 54 within a portion of the regeneration device 82 (FIG. 2), via a fluid line 50. The fluid line 50 may be mechanically similar to the fluid lines 46, 48 discussed above. The fluid channels 52, 54 may be passages formed within the portion of the regeneration device 82, and the channels 52, 54 may direct pressurized fluid to the second fluid passage 16 and the first fluid passage 18, respectively. The pump 44 may assist in directing the fluid to the channels 52, 54 at any desirable fluid pressure. In an exemplary embodiment, the pump 44 may direct fluid to the channels 52, 54 at approximately 250 psi or more.

### INDUSTRIAL APPLICABILITY

As shown in FIG. 2, in an exemplary embodiment of the present disclosure, the disclosed nozzle assembly 2 may be used in combination with a regeneration device 82 to assist in purging contaminants collected within a filter 84. Such filters 84 may include any type of filters known in the art, such as, for example, particulate filters, useful in extracting pollutants from a flow of liquid. It is understood that such filters may be used, for example, to extract particulates from a flow of exhaust gas. Such filters 84, and thus, the regeneration device 82, may be fluidly connected to an exhaust outlet of, for example, a diesel engine or other power source 78 known in the art. The power source 78 may be used in any conventional application where a supply of power is required. For example, the power source 78 may be used to supply power to stationary equipment, such as power generators, or other mobile equipment, such as vehicles. Such vehicles may include, for example, automobiles, work machines (including those for on-road, as well as off-road use), and other heavy equipment.

A flow of exhaust produced by the power source 78 may pass from the power source 78, through an energy extraction assembly 80, and into the regeneration device 82. It is understood that in an exemplary embodiment of the present disclosure, the energy extraction assembly 80 maybe omitted. Under normal power source operating conditions, the regeneration device 82 may be deactivated, and the flow of exhaust may pass through the regeneration device 82 to the filter 84, where a portion of the pollutants carried by the exhaust may be captured. Over time, however, the filter 84 may become saturated with collected pollutants, thereby hindering its ability to remove pollutants from the flow of exhaust. One or more diagnostic devices (not shown) may be used to detect, for example, filter temperature, flow rate, flow temperature, filtered flow particulate content, and/or other characteristics of the filter 84 and/or the flow, and may send this information to the controller 56. The controller 56 may use the information to determine when the filter 84 requires regeneration. This determination may also be based on a predetermined regeneration schedule, the gallons of fuel burned by the power source 78, and/or models, algorithms, or maps stored in a memory of the controller 56.

The regeneration device 82 may be configured to raise the temperature of a flow of exhaust passing through it, thereby generating an output flow capable of regenerating the filter 84. The temperature of the flow may be elevated by injecting a flammable fluid, such as, for example, diesel fuel, into the regeneration device 82 using the nozzle assembly 2, and igniting the fluid within the regeneration device 82. The operation of the nozzle assembly 2 will now be described in detail with respect to FIG. 1, unless otherwise noted. It is understood that the dashed lines originating from the controller 56 in FIG. 1 represent electrical or other control lines. The solid lines connecting each of the components of FIG. 1 represent fluid flow lines. It is further understood that the fluid discussed herein may be, for example, gasoline, diesel fuel, reformate, or any other conventional combustible fluid. The fluid may be ignited within the regeneration device 82 to increase the temperature of the exhaust flow and may be used to cool portions of the nozzle assembly 2 after a regeneration process is complete.

To begin injecting fluid using the nozzle assembly 2, the controller 56 may substantially open the valve 40. The first and second fluid passages 18, 16 may be supplied with fluid from the pump 44 at a pressure of, for example, approximately 250 psi. It is understood that the fluid maybe directed through the fluid line 50 to the channels 52, 54 at substantially the same pressure. Thus, when the valve 40 is substantially open, the third fluid passage 28 will be at a low pressure relative to the first fluid passage 18. Such a pressure differential will direct the fluid to flow from the first fluid passage 18 in the direction of arrow 70. The fluid may flow through the first radial passage 21 and into the third fluid passage 28. Once the fluid reaches the third fluid passage 28, the fluid may flow in the direction of arrow 68. The fluid may flow through the open valve 40 to the tank 42 via the fluid line 46. The fluid contained in the tank 42 may be at, for example, approximately atmospheric pressure. As described above, a portion of the first fluid passage 18 may have a conical restriction 15 proximate the first radial passage 21. This conical restriction 15 may be of a smaller diameter than, for example, a diameter of the third fluid passage 28 and a diameter of the first radial passage 21. Thus, when the valve 40 is substantially open, fluid entering the first fluid passage 18 at, for example, approximately 250 psi may not be capable of building up backpressure between the first radial passage 21 and the third fluid passage 28. More particularly, when the valve 40 is substantially open, fluid may not be capable of acting on the end 13 of the shaft 10.

Moreover, to begin injecting fluid the controller 56 may also control the valve 38 to achieve a relatively closed position in which the fluid may be forced through the housing 4 at a desired pressure. The desired pressure may correspond to a desired amount of fluid to be injected into the regeneration device 82. The amount of fluid injected by the nozzle assembly 2 may assist in controlling, for example, the combustion reaction within the regeneration device 82 and the amount of heat produced thereby. As the valve 38 is controlled to approach a substantially fully closed position while the valve 40 is substantially open, the amount of fuel injected by the nozzle assembly 2 may increase. In addition, when the valve 38 is in the relatively closed position and the valve 40 is substantially open, fluid may enter the second fluid passage 16 at approximately, for example, 250 psi and may pass in the direction of arrow 62 to the channel 24 of the housing 4. The fluid may pass through the slots 36 and may enter the chamber 14. The fluid may enter the chamber 14 at an angle based on the configuration of the slots 36 and may exit the orifice 12 in a conical direction as illustrated by arrows 72. Thus, a fluid pressure may build up in the chamber 14 proximate the tip 11 of the shaft 10. This built-up fluid pressure may be less than, for example, approximately 250 psi and greater than, for example, the pressure of the fluid flowing through the first radial passage 21. In particular, the built-up pressure in the chamber 14 may be greater than the pressure of the fluid disposed in the first radial passage 21. As a result, the shaft 10 may be biased in the direction of arrow 74 to the open position shown in FIG. 1, and the delivery of fluid between the end 13 of the shaft 10 and the stop 30 may be substantially cut off. Although the fluid may be supplied to the second fluid passage 16 at, approximately, 250 psi, the pressure of the fluid in chamber 14 may be less than, approximately, 250 psi due to pressure losses upstream of the chamber 14 and the controllable pressure setting of valve 38.

In the open position, the amount of fluid provided to the regeneration device 82 (FIG. 2) may be controlled by valve 38, and the nozzle assembly 2 may remain in the open position as long as the fluid pressure at the tip 11 of the shaft 10 is greater than the fluid pressure acting on the end 13 of the shaft 10 and/or the stop 30. During injection, a portion of the pressurized fluid in the chamber 14 may also be desirably removed from a central portion of the chamber 14 by the feed holes 17. The feed holes 17 may assist in delivering the removed fluid to the bypass passage 22 of the shaft 10 and this flow of removed fluid may assist in, for example, cooling components of the nozzle assembly 2 during injection. It is understood that the fluid delivered by the slots 36 may be made to swirl within the chamber 14 due to, for example, the pressure and/or the angle relative to the longitudinal axis 9 and the radial axis 99 at which the fluid is delivered. The fluid swirling proximate the central portion of the chamber 14 may have less kinetic energy than fluid swirling proximate an outer surface of the chamber 14, and may remain approximately stationary relative to the central portion of the chamber 14. Thus, removing fluid from the central portion of the chamber 14 through the feed holes 17 may minimize the disruption of the swirling fluid within the chamber 14.

In addition, it is understood that during extended regeneration processes, components of the nozzle assembly 2 may reach, for example, approximately 600 degrees Celsius or more. Thus, if fluid were to remain within components of the nozzle assembly 2, such as, for example, the slots 36 of the sleeve 8, at such elevated temperatures for extended periods of time, the fluid may begin to coke and/or corrode the components. Such coking and/or corrosion may clog the passages of such components and may reduce, for example, the effectiveness and/or the useful life of the nozzle assembly 2. Cooling the components of the nozzle assembly 2, as described above, may reduce coking and/or corrosion after repeated regeneration processes and may extend the life of the nozzle assembly 2. Moreover, continuously cycling fluid through the components of the nozzle assembly 2 while the shaft 10 is in both the open and closed positions may also reduce coking and/or corrosion and assist in extending the life of the nozzle assembly 2.

To stop injecting fluid into the regeneration device 82, the controller 56 may close the valve 40 and the valve 38 may remain in the relatively closed position discussed above. When the valve 40 is closed, fluid will be directed to the first fluid passage 18 at, for example, approximately 250 psi by the pump 44. The fluid will collect within, for example, the first fluid passage 18 and the first radial passage 21, and fluid disposed within the first radial passage 21 of the sleeve 8 will act on the end 13 of the shaft 10. This fluid may have a fluid pressure that is substantially equal to the pressure of the fluid entering the first fluid passage 18 (i.e., approximately 250 psi). Thus, the pressure of the fluid acting on the end 13 of the shaft 10 may be greater than the pressure of the built-up fluid acting on the tip 11 of the shaft 10 when the valve 40 is closed and the valve 38 is in the relatively closed position. This pressure differential will force the shaft 10 to move in the direction of arrow 76 until the tip 11 of the shaft 10 engages the orifice 12 of the cap 6. The shaft 10 may form a fluid seal with the cap 6 such that substantially no fluid may exit the orifice 12. As discussed above, when the shaft 10 is biased fully in the direction of arrow 76, the nozzle assembly 2 may be in the closed position. It is understood that when the nozzle assembly 2 is in the closed position, the valve 38 may be opened slightly to reduce the pressure of the fluid acting on the tip 11 of the shaft 10.

In addition, while the nozzle assembly 2 is in the closed position, the fluid entering the second fluid passage 16 may travel through the channel 24 in the direction of arrow 76. The fluid may pass through the slots 36 to the sealed chamber 14. The fluid may then be directed to the bypass passage 22 through the feed holes 17, and may travel through the escape channels 23 in the direction of arrow 64. The fluid may then enter the second radial passage 20 and may exit the housing 4 through the fourth fluid passage 26 in the direction of arrow 66. The fluid may pass through the valve 38 and may be directed to the low pressure tank 42 through the fluid line 48. As described above with respect to the open position of FIG. 1, when the nozzle assembly 2 is in the closed position, the fluid traveling through the slots 36, into the bypass passage 22, and around the second radial passage 21 may cool at least a portion of the nozzle assembly 2. Such cooling may reduce the level of coking and/or other corrosion-related reactions within the nozzle assembly 2. In addition, circulating fluid through the components of the nozzle assembly 2 while the regeneration device 82 (FIG. 2) is not in use may reduce the build-up of dirt or other pollutants within the components.

It will be apparent to those having ordinary skill in the art that various modifications and variations can be made to the disclosed nozzle assembly 2 without departing from the scope of the invention. For example, although the nozzle assembly 2 is disclosed herein as having multiple distinct components, it is understood that one or more of the distinct components, such as, for example, the sleeve 8 and the stop 30, may be combined to form a single component. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A nozzle assembly, comprising:
a housing defining a first fluid passage and a second fluid passage;
a sleeve disposed within the housing and fluidly connected to the first and second fluid passages;
a shaft disposed within the sleeve and movable between a closed position and an open position; and
at least one orifice in selective communication with a regeneration device.

2. The nozzle assembly of claim 1, wherein the housing further includes a third fluid passage fluidly connected to the first fluid passage, and a fourth fluid passage fluidly connected to the second fluid passage.

3. The nozzle assembly of claim 2, wherein the sleeve defines a first radial passage configured to direct a fluid between the first fluid passage and the third fluid passage.

4. The nozzle assembly of claim 2, wherein the sleeve defines a second radial passage configured to direct a fluid between the second fluid passage and the fourth fluid passage.

5. The nozzle assembly of claim 2, wherein the shaft defines a bypass passage in fluid communication with the second fluid passage and the fourth fluid passage.

6. The nozzle assembly of claim 1, wherein the sleeve further includes a plurality of slots fluidly connected to the second fluid passage.

7. The nozzle assembly of claim 6, wherein the plurality of slots are configured to direct a fluid to a chamber of the nozzle assembly when the shaft is in the open position.

8. The nozzle assembly of claim 1, further including a cap connected to the housing, the cap assisting in defining a chamber proximate the shaft.

9. The nozzle assembly of claim 8, wherein the cap defines the at least one orifice proximate the chamber and wherein the shaft substantially seals the at least one orifice when the shaft is in the closed position.

10. The nozzle assembly of claim 8, wherein the shaft defines at least one feed hole in fluid communication with the chamber.

11. The nozzle assembly of claim 10, wherein the at least one feed hole is configured to remove a fluid from a central portion of the chamber when the shaft is in the open position.

12. A nozzle assembly, comprising:
a housing defining a first fluid passage fluidly connected to a third fluid passage, and a second fluid passage fluidly connected to a fourth fluid passage;
a sleeve disposed within the housing;
a shaft disposed within the sleeve and movably disposed between an open position and a closed position, the shaft defining a bypass passage configured to direct fluid from the second fluid passage to the fourth fluid passage; and
at least one orifice in selective communication with a regeneration device.

13. The nozzle assembly of claim 12, wherein the sleeve defines a first radial passage configured to direct a fluid between the first fluid passage and the third fluid passage, and a second radial passage configured to direct a fluid between the second fluid passage and the fourth fluid passage.

14. The nozzle assembly of claim 13, wherein the sleeve further includes a plurality of slots configured to direct a fluid from the second fluid passage to a chamber of the nozzle assembly.

15. The nozzle assembly of claim 12, wherein the shaft further defines at least one feed hole configured to assist in directing fluid from the second fluid passage to the fourth fluid passage when the shaft is in the open position and the closed position.

16. A method of cooling a portion of a nozzle assembly, comprising:
directing a fluid to a chamber of the nozzle assembly when a shaft of the nozzle assembly is in an open position; and
directing a portion of the fluid from a central portion of the chamber to a bypass passage of the shaft, when the shaft is in the open position.

17. The method of claim 16, further including directing the portion of the fluid through at least one feed hole in fluid communication with the chamber and the bypass passage.

18. The method of claim 16, further including directing the fluid through a plurality of slots defined by a sleeve of the nozzle assembly.

19. The method of claim 16, further including directing the fluid through a radial passage defined by the sleeve.

20. The method of claim 16, further including substantially sealing an orifice of the chamber with the shaft when the shaft is in a closed position.
